(19) United States
(12) Patent Application Publication
(10) Pub. No.: US 2017/0019577 A1
(43) Pub. Date: Jan. 19, 2017

(54) SAFETY CIRCUIT FOR INFRARED AND LASER IMAGING DEVICES

(71) Applicant: Dell Products L.P., Round Rock, TX (US)

(72) Inventors: Geroncio O. Tan, Austin, TX (US); Thomas Lanzoni, Cedar Park, TX (US); Flaviu C. Chis, Leander, TX (US)

(21) Appl. No.: 14/802,781

(22) Filed: Jul. 17, 2015

(51) Int. Cl. H04N 5/235; H04N 5/225; H04N 5/232; H04N 5/33

(52) U.S. Cl. CPC H04N 5/2353; H04N 5/33; H04N 5/2256; H04N 5/23219

(57) ABSTRACT

Systems and methods for preventing over exposure to light during an image scan are disclosed. The system includes a camera, a light source, and a controller communicatively coupled to the camera and configured to instruct the camera to perform an image scan, and to enable an illumination current for the light source during the image scan. The system also includes a proximity sensor configured to detect a distance between the light source and a subject of the image scan, and to provide a proximity override to disable the illumination current during the image scan in response to a determination that the subject is at an unsafe distance from the light source.

### TECHNICAL FIELD

The present disclosure relates in general to information handling systems, and more particularly to a safety circuit for limiting exposure to a light source of an infrared (IR) or laser imaging device.

### BACKGROUND

As the value and use of information continues to increase, individuals and businesses seek additional ways to process and store information. One option available to users may be information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information may be handled, how the information may be handled, how much information may be processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications.

Information handling systems may include a variety of hardware and/or software components that may be configured to process, store, and/or communicate information. Information handling systems may also include an imaging device, such as an infrared (IR) or a laser imaging device. For example, an IR imaging device may be implemented in an iris scanner or a facial recognition system, that biometrically authenticates the identity of a user before allowing the user to access information on an information handling system. Imaging systems used in biometric authentication applications, such as an iris scanner or a facial recognition system, may employ an infrared (IR) light-emitting diode (LED) to illuminate to the subject during an authentication process. When irradiating the human body with IR light over an extended period of time, damage to skin or eye of the user may occur if the distance between the user and the IR LED is too short or the exposure time is too long.

### SUMMARY

In accordance with the teachings of the present disclosure, disadvantages and problems associated with user exposure to a light source may be substantially reduced or eliminated.

In accordance with one embodiment of the present disclosure, an imaging system includes a camera, a light source, and a controller communicatively coupled to the camera and configured to instruct the camera to perform an image scan, and to enable an illumination current for the light source during the image scan. The system also includes a proximity sensor configured to detect a distance between the light source and a subject of the image scan, and to provide a proximity override to disable the illumination current during the image scan in response to a determination that the subject is at an unsafe distance from the light source.

In accordance with another embodiment of the present disclosure, an imaging system includes a camera, a light source, and a primary controller communicatively coupled to the camera and configured to instruct the camera to perform an image scan, and to enable an illumination current for the source during the image scan. The system also includes a proximity sensor configured to detect a distance between the light source and a subject of the image scan and a hardware controller communicatively coupled to the proximity sensor and configured to dynamically set the magnitude of the illumination current based on the distance detected by the proximity sensor.

In accordance with one embodiment of the present disclosure, a method for preventing overexposure to light includes enabling an illumination current for a light source to illuminate a subject of an image scan, detecting the distance between the light source and the subject of the image scan, and providing a proximity override to disable the illumination current in response to a determination that the subject is at an unsafe distance from the light source.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with certain embodiments of the present disclosure;

FIG. 2 illustrates a block diagram of an imaging system, in accordance with certain embodiments of the present disclosure;

FIG. 3 illustrates a timing chart for driving an IR LED of an imaging system, in accordance with certain embodiments of the present disclosure;

FIG. 4 illustrates a timing chart for control signals of an imaging system, in accordance with certain embodiments of the present disclosure;

FIG. 5 illustrates a block diagram of an imaging system, in accordance with certain embodiments of the present disclosure;

FIG. 6 illustrates a flow chart for an example method for limiting the exposure of IR light, in accordance with certain embodiments of the present disclosure.

### DETAILED DESCRIPTION

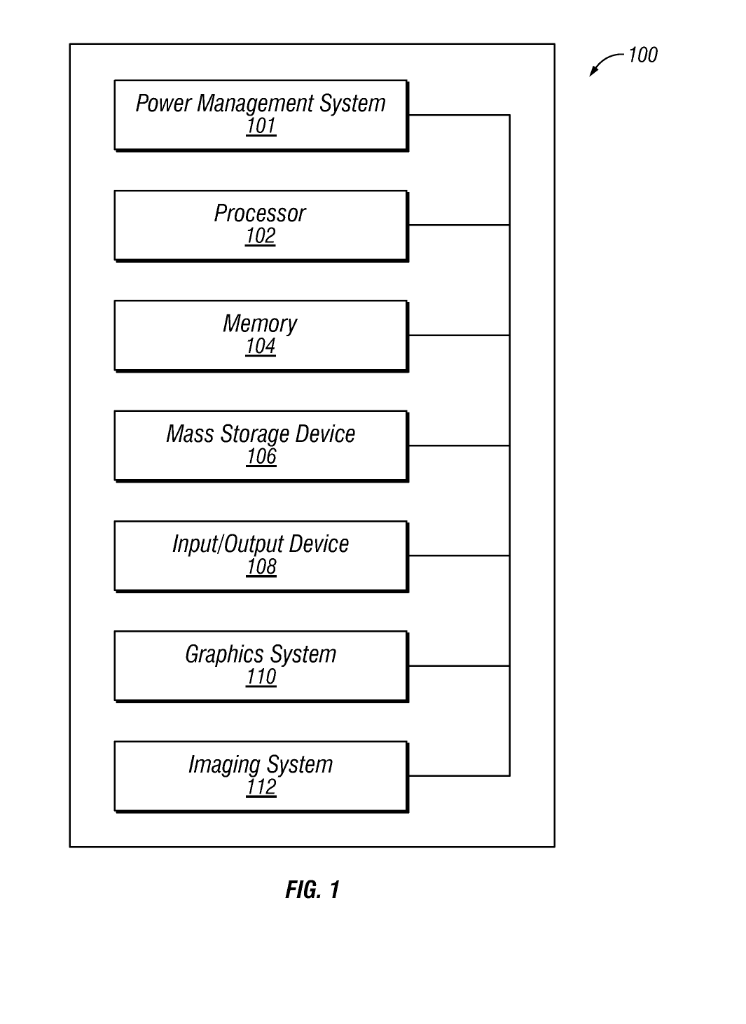

Preferred embodiments and their advantages are best understood by reference to FIGS. 1-6, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage resource, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

FIG. 1 illustrates a block diagram of an example information handling system 100, in accordance with certain embodiments of the present disclosure. Information handling system 100 may generally be operable to receive data from, and/or transmit data to, other information handling systems 100. In one embodiment, information handling system 100 may be a desktop computer, laptop computer, tablet computer, mobile wireless device, wireless communication device, a wearable computing device, and/or any other suitable computing device. In the same or alternative embodiments, information handling system 100 may be a server or a storage array configured to include multiple storage resources (e.g., hard drives) in order to manage large amounts of data. In some embodiments, information handling system 100 may include, among other suitable components, processor 102, memory 104, mass storage device 106, input-output device 108, graphics system 110, and imaging system 112.

Power management system 101 may include any suitable device or devices to supply power to one or more other components of information handling system 100. For example, power management system 101 may include one or more AC-to-DC converters configured to convert AC power from an external power source into an DC voltage. Power management system 101 may also include one or more DC-to-DC converters that may be configured to convert for example, a high-power DC voltage source into one or more lower power DC voltage sources that may be utilized by other components of information handling system 100 (e.g., processor 102 and memory 104). Power management system 101 may also include a battery, which may be utilized to power one or more components of information handling system 100 when an external power source is not available.

Processor 102 may include any system, device, or apparatus operable to interpret and/or execute program instructions and/or process data. Processor 102 may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 102 may interpret and/or execute program instructions and/or process data stored in memory 104, mass storage device 106, and/or another component of system 100.

Memory 104 may be communicatively coupled to processor 102 and may include any system, device, or apparatus operable to retain program instructions or data for a period of time (e.g., computer-readable media). Memory 104 may include random access memory (RAM), electrically erasable programmable read-only memory (EEPROM), flash memory, magnetic storage, opto-magnetic storage, or any suitable selection and/or array of volatile or non-volatile memory that retains data after power to system 100 may be removed.

Mass storage device 106 may include one or more storage resources (or aggregations thereof) communicatively coupled to processor 102 and may include any system, device, or apparatus operable to retain program instructions or data for a period of time (e.g., computer-readable media). Mass storage device 106 may retain data after power to system 100 may be removed. Mass storage device 106 may include one or more hard disk drives (HDDs), magnetic tape libraries, optical disk drives, magneto-optical disk drives, compact disk drives, compact disk arrays, disk array controllers, solid state drives (SSDs), and/or any computer-readable medium operable to store data.

Input-output device 108 may be communicatively coupled to processor 102 and may include any instrumentality or aggregation of instrumentalities by which a user may interact with system 100 and its various information handling resources by facilitating input from a user allowing the user to manipulate system 100 and output to a user allowing system 100 to indicate effects of the user's manipulation. For example, input-output device 108 may permit a user to input data and/or instructions into system 100 (e.g., via a keyboard, pointing device, and/or other suitable means), and/or otherwise manipulate system 100 and its associated components. In these and other embodiments, input-output device 108 may include other user interface elements (e.g., a keypad, buttons, and/or switches placed in proximity to a display) allowing a user to provide input to system 100.

Graphics system 110 may be communicatively coupled to processor 102 and may include any system, device, or apparatus operable to receive and process video information. Graphics system 110 may additionally be operable to transmit digital video information to a display. Graphics system 110 may include any internal graphics capabilities including for example, but not limited to, integrated graphics or a graphics card. Graphics system 110 may include graphics drivers, graphics processors, and/or any other suitable components.

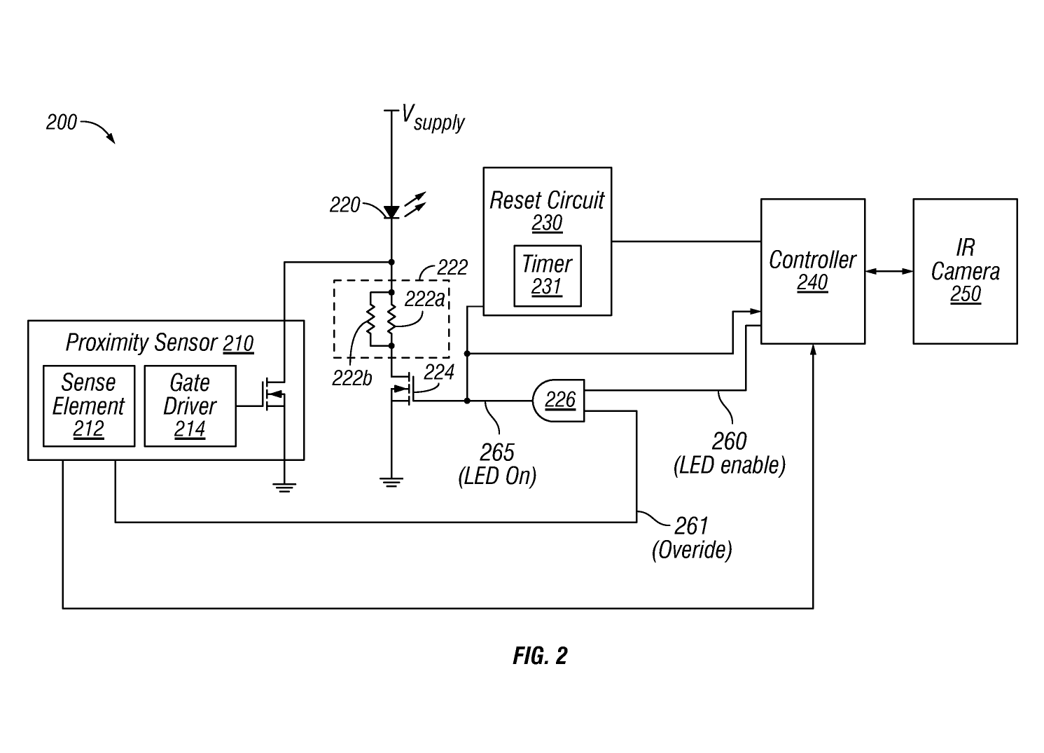

Imaging system 112 may include logic or instructions for execution by a processor such as processor 102. The logic or instructions of imaging system 112 may be resident within memory 104 or mass storage device 106 communicatively coupled to processor 102. Imaging system 112 may be implemented by any suitable software, hardware, firmware, or combination thereof configured as described herein. For example, as described in further detail below with reference to FIG. 2, imaging system 112 may include hardware safety circuits that may be initialized through software, but may otherwise operate in a software-independent manner in order to provide safety measures even in the event of a software lockup.

FIG. 2 illustrates a block diagram of imaging system 200, in accordance with certain embodiments of the present disclosure. Imaging 200 may include controller 240 and infrared (“IR”) camera 250. Controller 240 may be communicatively coupled to IR camera 250 and may include any suitable software, hardware, firmware, or combination thereof to control the operation of IR camera 250 during an IR image scan (e.g., a facial recognition scan or an iris scan). The IR image scan may be used to biometrically authenticate the identity of a user of an information handling system (e.g., information handling system 100) in which imaging system 200 is implemented.

In order to prevent spoofing and to improve accuracy, an biometric authentication imaging system employing facial recognition and/or iris scanning, may use an IR light-emitting diode (“LED”) to illuminate the subject being scanned. For example, controller 240 may be configured to turn on a light source such as LED 220 during an IR image scan. In some embodiments, controller 240 may be communicatively coupled to gate 226, and may provide an LED-enable signal 260 to gate 226. In some embodiments, gate 226 may be implemented as an AND gate. In addition to receiving LED-enable signal 260 from controller 240, gate 226 may receive override signal 261 from proximity sensor 210. As described in further detail below with reference to the operation of proximity sensor 210, override signal 261 may be driven low in order to disable LED 220 in response to certain safety criteria. But during normal operation, proximity sensor 210 may set override signal 261 high, thereby allowing gate 226 to drive transistor 224 based on LED-enable signal 260.

When override signal 261 and LED-enable signal 260 are both high, gate 226 may drive the LED-on signal 265 at the gate of transistor 224 high. In some embodiments, transistor 224 may be an N-type Metal Oxide Semiconductor Field Effect Transistor (“NMOS”), and may turn on when LED-on signal 265 is driven high. As shown in FIG. 2, transistor 224 may be coupled in series with resistor 224 and LED 220, between a power supply node (“V_{supply}”) and ground. Accordingly, when transistor 224 turns on, a current may flow through LED 220 that may be sufficient for LED 220 to illuminate the subject of the IR image scan. For the purposes of the present disclosure, such a current may be referred to as an illumination current. The level of illumination provided by LED 220 may depend on the illumination current, which may in turn depend on the resistance of resistor 222. Accordingly, resistor 222 may have a resistance value that is selected based on a desired level of illumination. When the illumination current is turned on, heat may be generated due to the power dissipated in resistor 222. To better dissipate such heat, resistor 222 may be implemented, for example, by two or more resistors 222a and 222b coupled in parallel.

Although FIG. 2 is illustrated with gate 226 implemented as a AND gate, and transistor 224 implemented as an NMOS, imaging system 200 may be implemented with any suitable components to allow controller 240 to drive LED 220 with an illumination current during normal operation. For example, gate 226 may be implemented with any combination of logic gates (e.g., NAND gates, OR gates, NOR gates, inverters) to receive any suitable LED-enable signal from controller 240 and to turn on transistor 224 during normal operation of an IR image scan. Moreover, transistor 224 may be implemented with any suitable type of transistor, such as an NMOS, a P-type Metal Oxide Semiconductor Field Effect Transistor (“PMOS”), a bipolar junctiontransistor, or a J-FET. Imaging system 200 may implement a mechanical switch or any other suitable switching device in addition to, or in place of, transistor 224. Moreover, although transistor 224 is illustrated in FIG. 2 as being coupled between LED 220 and ground, and may thus be referred to as sinking the illumination current that passes through LED 220, transistor 224 may also be coupled between Vsupply and LED 220 such that transistor 224 sources the illumination current that passes through LED 220. For either embodiment, transistor 224 may be referred to generally as providing the illumination current to LED 220.

In order to prevent over exposure of the user (e.g., the user's skin, cornea, or iris) to IR light, imaging system 200 may also include one or more safety circuits. For example, imaging system 200 may include proximity sensor 210 and reset circuit 230.

Proximity sensor 210 may ensure that the subject of an IR image scan is at a safe distance from the source of IR light (e.g., LED 220) during the scan. Proximity sensor 210 may include sense element 212, gate driver 214, and transistor 216. Gate driver 214 may be configured to drive transistor 216, which may in turn be coupled to LED 220. Gate driver 214 may be configured to pulse the gate of transistor 216 such that transistor 216 provides a pulsing current to LED 220. The pulsing current may drive LED 220 to emit a modulated IR beam. Portions of the modulated IR beam may be reflected from the subject of the IR image scan back toward proximity sensor 210, and may in turn be sensed by sense element 212 in order to determine the distance between LED 220 and the subject of the IR image scan.

As shown in FIG. 2, in some embodiments, a single LED (e.g,. LED 220) may be configured to emit a modulated IR beam for purposes of proximity sensing, and to illuminate the subject of an IR image scan during the scan. In some embodiments, however, separate LEDs may be utilized to emit a modulated IR beam for purposes of proximity sensing, and to illuminate the subject of an IR image scan during the scan.

The power of the modulated IR beam emitted by LED 220 may be less than the power utilized to illuminate a subject during an IR image scan. For example, the power of the modulated IR beam emitted by LED 220 may be an order of magnitude less than the power emitted by LED 220 to illuminate the subject of an IR image scan. Moreover, the pulsing current may drive the LED 220 at a very low duty cycle for proximity sensing. For example, the pulsing current may drive LED 220 at a duty cycle as low as 0.33% (1/300) or lower. Accordingly, the modulated IR beam emitted by LED 220 due to the pulsing current may, by itself, have a low enough magnitude to avoid over exposure of the user to IR light over an extended period of time. Moreover, the pulsing current may be pulsed at a frequency that is not visible to the human eye. Thus, the modulated IR beam may be utilized throughout an active session of imaging system 200 to ensure that the subject of an IR image scan is at a safe distance from LED 220.

Proximity sensor 210 may continuously monitor the proximity of the subject of an IR image scan throughout an active session of imaging system 200 to ensure the subject of the IR image scan is at a safe distance from LED 220. For example, proximity sensor 210 may determine whether the subject of the IR image scan is at a distance greater than or equal to a low threshold. The low threshold may be based on the minimum distance at which the subject of the IR image scan may be safely exposed to the IR light emitted by LED 220. In some embodiments, the low threshold may be set to 6 cm for example. In other embodiments, the low threshold may be higher or lower than 6 cm, and may depend on the strength of IR light provided by LED 220.

If proximity sensor 210 senses that the subject of the IR image scan is at a distance less than the low threshold, proximity sensor 210 may send override signal 261 to gate 226. The override signal may disable transistor 224 and thus prevent transistor 224 from providing an illumination current to LED 220. As described above, in some embodiments, gate 226 may be implemented as an AND gate. In such embodiments, proximity sensor 210 may set override signal 261 to a logical low level in order to disable transistor 224, and thus prevent LED 220 from illuminating the subject of the IR image scan.

In some embodiments, proximity sensor 210 may employ hysteresis at the low threshold. For example, if the proximity sensor 210 disables the illumination current in response to sensing that the subject of the IR image scan moved within a low threshold of 6 cm from LED 220, proximity sensor 210 may subsequently release the override signal and allow the illumination current to turn back on when the subject of the IR image scan moves outside of a hysteresis threshold of 10 cm from LED 220. Such hysteresis may prevent controller 240 and proximity sensor 210 from repeatedly enabling and disabling the illumination current through LED 220 when the subject of the IR image scan remains, for a period of time, at a distance from LED 220 at or near the low threshold.

In some embodiments, proximity sensor 210 and gate 226 may be implemented in hardware in order to provide a software-free feedback loop that ensures the subject of the IR image scan is at a safe distance from the source of IR light (e.g., LED 220) during an IR image scan. Accordingly, the safety features provided by proximity sensor 210 may be immune to software-based delays and/or software crashes. For example, after controller 240 (which may include hardware, software, or a combination thereof) provides LED-enable signal 260 to start an IR image scan, a hardware-based implementation of proximity sensor 210 and gate 226 may ensure the subject of the IR image scan is at a safe distance from the source of IR light (e.g., LED 220) during an IR image scan regardless of any software delays experienced in controller 240 or experienced in other portions of an information handling system including imaging system 200.

Proximity sensor 210 may also employ a high threshold in conjunction with the low threshold to prevent false readings by proximity sensor 210. For example, if sensing element 212 of proximity sensor 210 is covered during an IR image scan, or if the subject of the IR image scan is too close to proximity sensor 210 and/or LED 220 to reflect the modulating IR beam from LED 220 to proximity sensor 210, then proximity sensor 210 may falsely detect that the subject of the IR image scan is safely at an infinite distance from the source of the illuminating IR light (e.g., LED 220). To prevent an illumination current in LED 220 from being enabled based on such a false reading, controller 240 may require a valid reading from proximity sensor 210 between the low threshold and the high threshold before setting LED-enable signal 260 high to enable the illumination current. In some embodiments, the high threshold may be set, for example, between 30 cm and 120 cm.

Subsequently, after controller 240 has enabled the illumination current, proximity sensor 210 may monitor the proximity of the subject of the IR image scan as described above to ensure the subject is at a safe distance (e.g., ≧6 cm) from LED 220. When the illumination current is enabled, proximity sensor 210 may also monitor any fast changes in the proximity of the subject being scanned. A fast change in the sensed proximity of the subject of the IR image scan may occur, for example, if sensing element 212 of proximity sensor 210 accidentally becomes covered during an IR image scan. To prevent the continued illumination of the subject in such an instance, proximity sensor 210 may trigger override signal 261 to disable the illumination current if the rate of change of the sensed proximity is greater than a predetermined threshold rate of change.

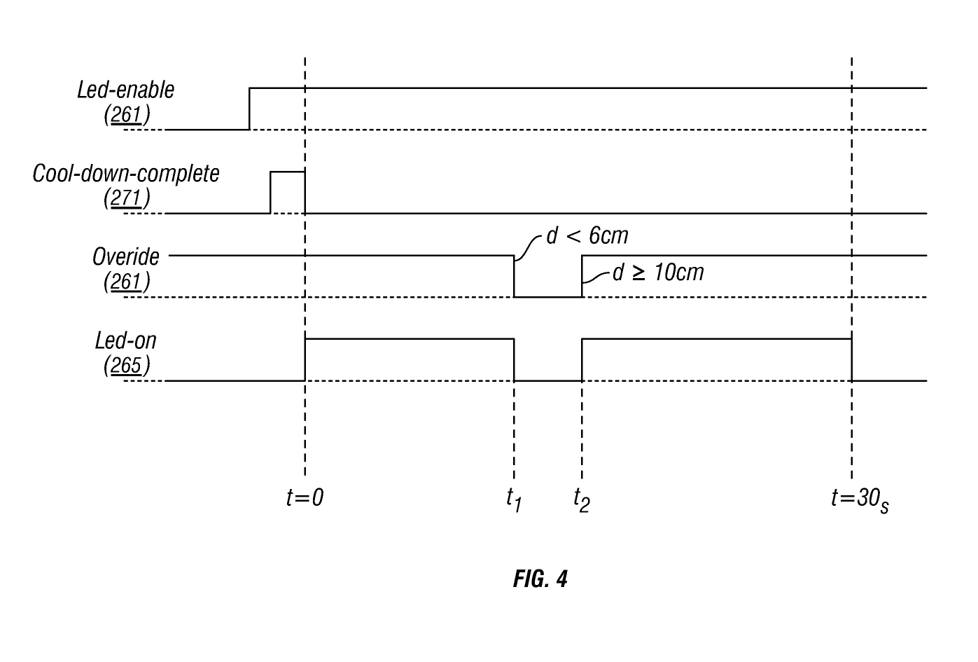

Imaging system 200 may also include reset circuit 230, which may limit the time that LED 220 illuminates the subject of an IR image scan. Reset circuit 230 may include reset timer 231. As described in further detail below with reference to FIG. 4, controller 240 may instruct reset circuit 230 to start reset timer 231 when LED-enable signal 260 is initially driven high to enable the illumination current. After a threshold amount of time (e.g., thirty seconds) from the time at which LED-enable signal 260 is initially driven high, reset circuit 230 may override the enable signal and force LED-on signal 265 low, thus disabling the illumination current provided by transistor 224. In some embodiments, the output of reset circuit 230 may include an open drain output that may overcome the outputs of other circuits (e.g., gate 226) driving LED-on signal 265 when reset circuit 230 forces the LED-on signal 265 low.

In some embodiments, the threshold amount of time may be based on the amount of time at which a user may safely be exposed to the IR light from LED 220 at the low threshold distance (e.g., 6 cm) described above with reference to proximity sensor 210. In some embodiments, the threshold amount of time may be based on the thermal energy produced by the illumination current in, for example, LED 220 and resistor 220, and the ability of imaging system 200 to dissipate heat over a period of time. The threshold amount of time may be for example, any time from less than six seconds, to thirty seconds, to greater than sixty seconds.

After reset circuit 230 enters a reset state, thus pulling LED-on signal 265 low and disabling the illumination of LED 220, reset circuit 230 may stay in the reset state until cool-down signal 270 is toggled by controller 240. For example, during an IR image scan, controller 240 may monitor how long the illumination current through LED 220 was enabled based on the LED-enable signal 260 and/or LED-on signal 265. Controller 240 may determine a minimum cool-down time based on the amount of time that the illumination current through LED 220 was enabled. A cool-down timer in controller 240 may track the time since the illumination current was disabled at the end of the previous IR image scan. After the minimum time has expired, controller 240 may toggle the cool-down-complete signal 270, which may place reset circuit 230 into a set state. After being set by cool-down-complete signal 270, reset circuit 230 may be ready to again start reset timer 231 and subsequently override the LED-on signal 265 after a threshold amount of time during a subsequent IR image scan.

Similar to proximity sensor 210, reset circuit 230 may, in some embodiments, be implemented in hardware. Accordingly, reset circuit 230 may provide a software-free feedback loop that ensures that an illumination current in LED 220 is turned off after a maximum threshold amount of time. For example, once controller 240 (which may include hardware, software, or a combination thereof) toggles cool-down-complete signal 270, a hardware-based implementation of reset circuit 230 may ensure that the illumination current provided by transistor 224 is disabled after a threshold amount of time regardless of any software delays experienced in controller 240 or experienced in other portions of an information handling system including imaging system 200.

Although imaging system 200 is described above with reference to FIG. 2 as performing an IR imaging scan for the purposes of biometric authentication, elements of imaging system 200, including the proximity sensor 210 and/or reset circuit 230, may be implemented in any suitable imaging system. For example, in some embodiments, imaging system 200 may include a laser in place of LED 220 and a laser scanning camera in place of IR camera 250. In such embodiments, proximity sensor 210 and/or reset circuit 230 may ensure the safe operation of the laser in a laser scanning application in the same manners as described above for the safe operation of LED 220 in a biometric authentication application.

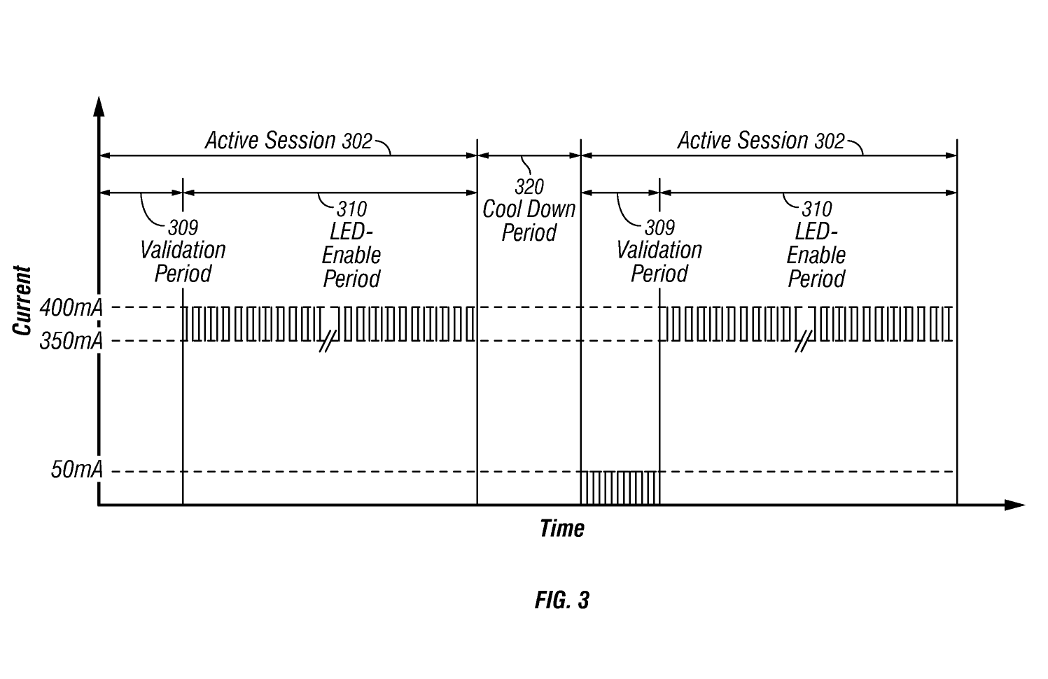

FIG. 3 illustrates a timing chart for driving an IR LED of an imaging system, in accordance with certain embodiments of the present disclosure. As shown in FIG. 3, active session 302 of an imaging system (e.g., imaging system 200) may include validation period 309 and LED-enable period 310. As described above with reference to FIG. 2, proximity sensor 210 may provide a pulsing current to LED 220 prior to the enabling of the illumination current. If proximity sensor 210 senses and reports to controller 240 a valid proximity (e.g., between a low threshold of 6 cm and a high threshold of 60 cm) during validation period 309, controller 240 may enable the illumination current during LED-enable period 310.

The illumination current may be higher than the pulsing current. For example, as shown in FIG. 3, the pulsing current may modulate between 0 mA and 50 mA, and the illumination current may be a steady 350 mA. As described above with reference to FIG. 2, the pulsing current may continue to be utilized to sense the proximity of the subject of the IR image scan during the IR image scan. Accordingly, the modulating current may be added to the illumination current during LED-enable period 310. Thus, as shown in FIG. 3, the total current through LED 220 may be modulated between 350 mA and 400 mA during the LED-enable period 310.

As described above with reference to FIG. 2, reset circuit 230 may limit the time during which the illumination current may be enabled. Thus, LED-enable period 310 concludes within the threshold time (e.g., 30 seconds) determined by reset circuit 230. As also described above with reference to FIG. 2, controller 240 may determine a cool-down time based on the amount of time that LED 220 was enabled during the previous IR image scan. Accordingly, as shown in FIG. 3, the pulsing current and the illumination current may be disabled during cool-down period 320 as determined by controller 240. After a sufficient cool-down period as determined by controller 240, another active session 302 may begin.

FIG. 4 illustrates a timing chart for control signals of an imaging system, in accordance with certain embodiments of the present disclosure. The timing of the signals illustrated in FIG. 4 may be referenced in conjunction with the block diagram of imaging system 200 illustrated in FIG. 2. As shown by the timing signals in FIG. 4, reset circuit 230 may limit the amount of time that the illumination current of LED 220 is enabled during an IR image scan. Moreover, within the time window set by reset circuit 230, proximity sensor 210 may disable the illumination current in the event that the subject of the IR image scan moves within an unsafe distance from LED 220.

During an active session of imaging system 200, controller 240 may set LED-enable signal 260 high in order to enable the illumination current through LED 220. If a sufficient amount of cool-down time has passed since the previous IR image scan, controller 240 may also toggle cool-down-complete signal 270 in order to place reset circuit 230 into a set state. In the set state, reset circuit 230 may allow other circuits (e.g., gate 226) to drive LED-on signal 265. After reset circuit 230 releases the LED-on signal 265, gate 226 may drive LED-on signal 265 high at time t=0 based on the high LED-enable signal 260 and the high override signal 261.

At time t₁, the subject being illuminated by LED 220 may move to distance that is less than the low threshold (e.g., 6 cm) of proximity sensor 210. Accordingly, proximity sensor 210 may set override signal 261 low, thus forcing LED-on signal 265 low and disabling the illumination current through LED 220. At time t₂, the subject being illuminated by LED 220 may move back to a distance that is greater than the hysteresis threshold (e.g., 10 cm) of proximity sensor 210. Accordingly, proximity sensor 210 may return override signal 261 to a high state, thus allowing LED-on signal 265 to return to a high state that turns the illumination current back on.

As described above, reset circuit 230 may limit the amount of time that the illumination current may be enabled. For example, reset circuit 230 may count the time starting at time t=0. After a threshold amount of time (e.g., thirty seconds), reset circuit 230 may force LED-on signal 265 low. Accordingly, the illumination current may be disabled until controller 240 initiates a subsequent IR image scan.

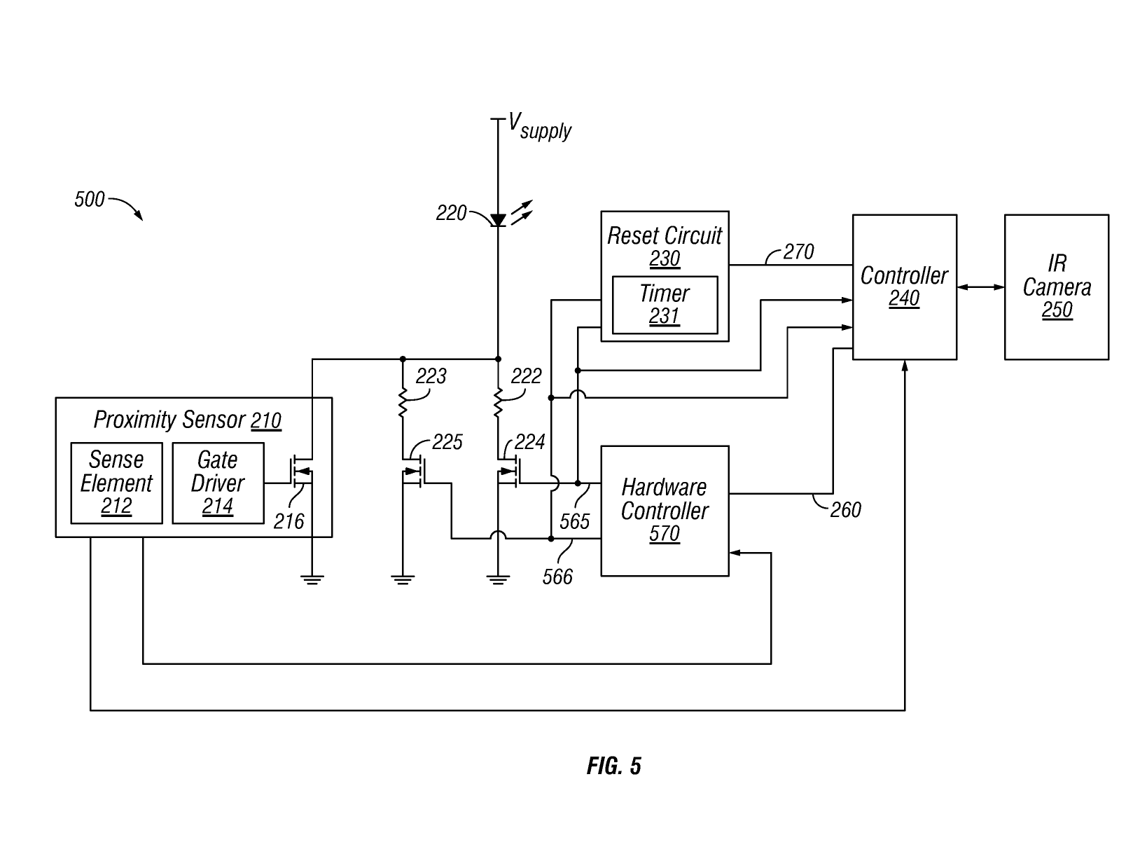

FIG. 5 illustrates a block diagram of a imaging system, in accordance with some embodiments of the present disclosure. Imaging system 500 may operate in similar manner as imaging system 200 described above with reference to FIGS. 2-4. For example, controller 240 may provide LED-enable signal 260 to enable an illumination current in LED 220. However, in imaging system 500, the magnitude of the illumination current may be dynamically driven to correspond to the distance, between LED 220 and the subject being illuminated, that is sensed by proximity sensor 210.

Imaging system 500 may include hardware controller 570. Hardware controller 570 may receive a distance measurement from proximity sensor 210 and may control the illumination current to LED 220 such that the level of IR illumination from LED 220 is safe at the measured distance. For example, if proximity sensor 210 senses that the subject being illuminated is at a first distance (e.g., 10 cm) from LED 220, hardware controller 570 may set the illumination current such that LED 220 emits an amount of IR light that is safe at the first distance. If proximity sensor 210 later senses that the subject moves to a second distance from LED 220, proximity sensor 210 may dynamically adjust the measurement value provided to hardware controller 570. Hardware controller 570 may set another level of illumination current such that LED 220 emits an amount of IR light that is safe at the second distance. The maximum amount of IR light that is safe may increase as the distance between LED 220 and the subject being illuminated increases. Accordingly, the magnitude of the illumination current may be increased as the distance between LED and the subject being illuminated increases.

In some embodiments, hardware controller 570 may be configured to drive multiple transistors, such as transistors 224 and 225 shown in FIG. 5. Transistor 224 and resistor 222 may be coupled in series with LED 220. Transistor 225 and resistor 223 may also be couple in series with LED 220, but in parallel with the combination of transistor 224 and resistor 222.

The current passing through transistor 224 when LED-on signal 565 is driven high depends on resistor 222. Likewise, the current passing through transistor 225 when LED-on signal 566 is driven high depends on resistor 223. In some embodiments, resistor 223 may have a smaller value than resistor 222. Thus, the current provided by transistor 225 when LED-on signal 566 is driven high may be larger than the current provided by transistor 224 when LED-on signal 565 is driven high. For example, the resistance of resistor 222 may be set such that a first illumination current passing through transistor 224 is 350 mA when LED-on signal 565 is driven high, and the resistance of resistor 223 may be set such that a second illumination current passing through transistor 225 is 700 mA when LED-on signal 566 is driven high. Accordingly, hardware controller 570 may dynamically set the illumination current through LED 220 by separately driving transistor 224 and transistor 225 based on a reading from proximity sensor 210.

In some embodiments, hardware controller 570 may dynamically set the illumination current through LED 220 by comparing a proximity reading from proximity sensor 210 against multiple thresholds. A low threshold (e.g., 6 cm) may be based on the distance for which a first illumination current (e.g., 350 mA) is safe. An intermediate threshold (e.g., 30 cm) may be determined based on the distance for which a second illumination current (e.g., 700 mA) is safe. And, as described above with reference to FIG. 2, a high threshold (e.g., 60 cm) may be utilized to ensure that the reading from proximity sensor 210 is a valid reading. In such embodiments, if proximity sensor 210 senses that the subject of the IR image scan is at a distance from LED 220 less than the low threshold (e.g., 6 cm), hardware controller 570 may drive both LED-on signal 565 and LED-on signal 566 low in order to provide no illumination current. If proximity sensor 210 senses that the subject of the IR image scan is at a distance from LED 220 between the low threshold (e.g., 6 cm) and the intermediate threshold (e.g., 30 cm), hardware controller 570 may drive LED-on signal 565 high and LED-on signal 566 low in order to provide a first illumination current (e.g., 350 mA) that is safe at the sensed distance. Further, if proximity sensor 210 senses that the subject of the IR image scan is at a distance from LED 220 between the intermediate threshold (e.g., 30 cm) and the high threshold (e.g., 60 cm), hardware controller 570 may drive LED-on signal 565 low and LED-on signal 566 high in order to provide a second illumination current (e.g., 700 mA) that is safe at that sensed distance.

Although hardware controller 570 is described above as adjusting the illumination current by alternately turning on transistors 224 and 225, hardware controller 570 may drive one or more transistors in any suitable manner to dynamically set the illumination current through LED 220. For example, in some embodiments, hardware controller 570 may be configured to drive the gate of a single transistor coupled in series with LED 220 with an analog drive signal in order to dynamically adjust the illumination current provided by the single transistor.

In other embodiments, hardware controller 570 may drive a transistor, such as transistor 224, with a pulse-width modulated (PWM) drive signal. In such embodiments, resistor 222 may be set such that transistor 224 provides an illumination current of 1000 mA, for example, when turned on with a 100% duty cycle. Hardware controller may dynamically adjust the duty cycle to provide a time-averaged illumination current to LED 220. For example, if proximity sensor 210 senses that the subject of the IR image scan is at a distance from LED 220 between the low threshold (e.g., 6 cm) and the intermediate threshold (e.g., 30 cm), hardware controller 570 may drive transistor 224 at a first duty cycle (e.g., 35%) to provide a first time-averaged illumination current (e.g., 350 mA). Further, if proximity sensor 210 senses that the subject of the IR image scan is at a distance from LED 220 between the intermediate threshold (e.g., 30 cm) and the high threshold (e.g., 60 cm), hardware controller 570 may drive transistor 224 at a second duty cycle (e.g., 70%) in order to provide a second time-averaged illumination current (e.g., 700 mA). The frequency of the pulse width modulation may be lower (e.g., ten times lower) than the frequency of the pulsing current from proximity sensor 210, such that the PWM frequency of the illumination current does not interfere with the proximity measurement. Moreover, the PWM frequency may be high enough to be unnoticed by the human eye.

In some embodiments, proximity sensor 210 and hardware controller 570 may be implemented in hardware in order to provide a software-free feedback loop that ensures the subject of the IR image scan is at a safe distance from the source of IR light (e.g., LED 220) during an IR image scan. Accordingly, the safety features provided by proximity sensor 210 may be immune to software-based delays and/or software crashes.

Similar to imaging system 200 described above with reference to FIG. 2, imaging system 500 may provide biometric authentication for the user of an information handling system in which imaging system 500 is implemented. However, elements of imaging system 500, including the proximity sensor 210, reset circuit 230, and/or hardware controller 570, may be implemented in any suitable imaging system. For example, in some embodiments, imaging system 500 may include a laser in place of LED 220 and a laser scanning camera in place of IR camera 250. In such embodiments, proximity sensor 210 and/or reset circuit 230 may ensure the safe operation of the laser in a laser scanning application in the same manners as described above with reference to FIG. 5.

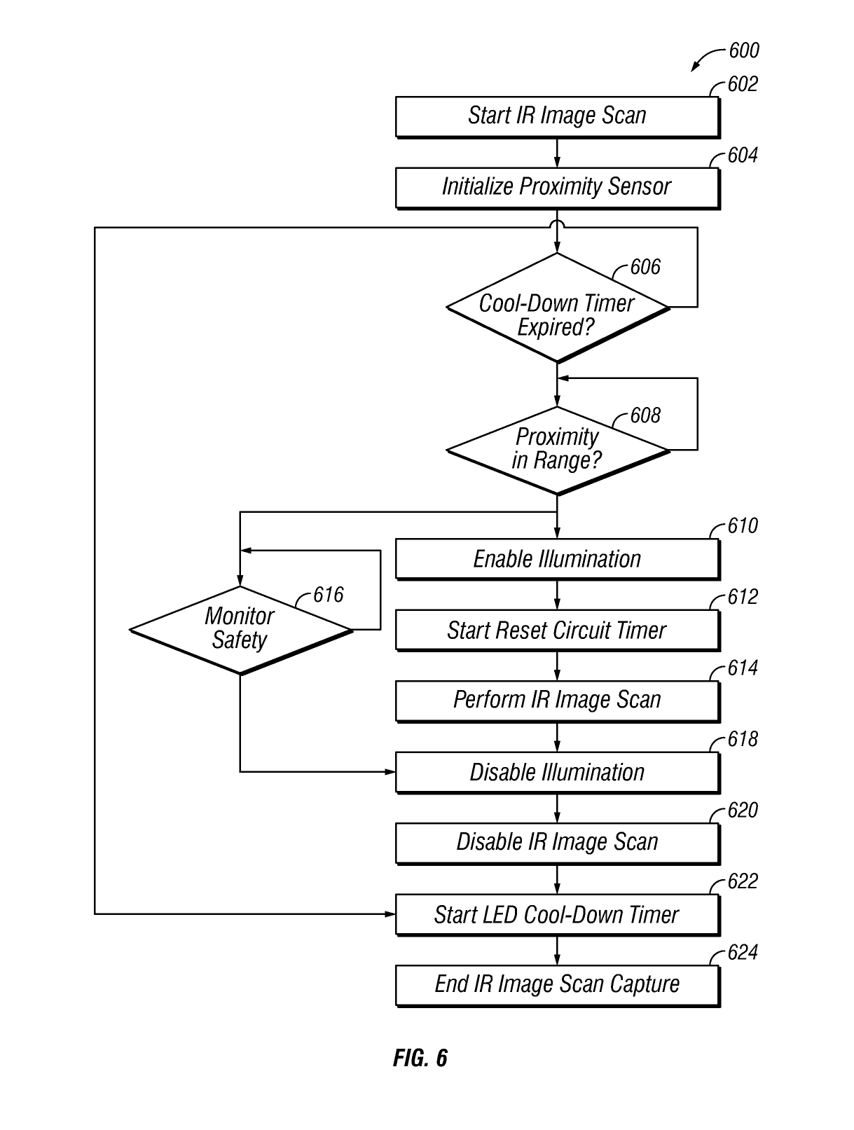

FIG. 6 illustrates a flow chart for an example method for limiting the exposure of IR light, in accordance with certain embodiments of the present disclosure. Although the steps of method 600 are described below with reference to imaging system 200, the steps of method 600 may be performed by any suitable imaging system (e.g., imaging system 500). Further, although FIG. 6 discloses a particular number of steps to be taken with respect to method 600, method 600 may be executed with greater or lesser steps than those depicted in FIG. 6. In addition, although FIG. 6 discloses a certain order of steps to be taken with respect to method 600, the steps comprising method 600 may be completed in any suitable order.

Method 600 may begin at step 602, where imaging system 200 may start an active session for an iris scan.

At step 604, the proximity sensor may be initialized. For example, controller 240 may communicate with proximity sensor 210 and may set parameters for proximity sensor 210, such as the low threshold, the hysteresis threshold, and the high threshold, for the measurements of proximity sensor 210. As an example, the low threshold may be set to 6 cm, the hysteresis threshold may be set to 10 cm, and the high threshold may be set to 60 cm.

At step 606, controller 240 may query whether a cool-down timer has expired. For example, as described above with reference to FIG. 2, controller 240 may determine a cool-down time based on the amount of time that LED 220 was enabled during the previous IR image scan. A cool-down timer within controller 240 may track the time since the previous IR image scan completed. If the cool-down timer has not reached the required cool-down time, the cool-down timer may keep counting. But when the cool-down timer reaches the required cool-down time, method 600 may proceed to step 608.

At step 608, proximity sensor 210 may determine whether the subject of the IR image scan is within an acceptable range of distances from LED 220. For example, proximity sensor 210 may determine whether the subject of the IR image scan is at a distance from LED 220 that is between the low threshold (e.g., 6 cm) and the high threshold (e.g., 60 cm). Requiring that the subject of the IR image scan is at a distance from LED 220 that is higher than the low threshold may ensure that the subject is not over exposed to the IR light during the IR image scan. Further, requiring that the subject of the IR image scan is at a distance from LED 220 that is lower than the high threshold may ensure that proximity sensor 210 has a valid reading. If the subject of the IR image scan is within an acceptable range, method 600 may proceed to step 610.

At step 610, controller 240 may enable the illumination of LED 220. For example, controller 240 may set LED-enable signal 260 high. Controller 240 may also toggle cool-down-complete signal 270 in order to place reset circuit 230 into a set state. In the set state, reset circuit 230 may allow other circuits (e.g., gate 226) to drive LED-on signal 265 high. Accordingly, transistor 224 may provide LED 220 with an illumination current, and LED 220 may illuminate the subject of the IR image scan.

As described above with reference to FIG. 2, reset circuit 230 may control the maximum amount of time that LED 220 may be enabled during an iris scan. Reset circuit 230 may include reset timer 231 that may track the time since the LED-on signal is initially driven high. At step 612, reset timer 231 of reset circuit 230 may start.

At step 614, the IR image scan may be performed. For example, while LED 220 is illuminating the subject of the IR image scan, controller 240 may instruct IR camera 250 to perform an IR image scan (e.g., a facial recognition scan or an iris scan).

While steps 610, 612, and 614 are performed, step 616 may be performed in parallel. At step 616, the safety of the IR image scan may be monitored. For example, as described above with reference to FIG. 2, proximity sensor 210 may ensure that the subject of the IR image scan remains at a safe distance from LED 220 to prevent over exposure. For example, proximity sensor 210 may sense the distance between LED 220 and the subject of the IR image scan. If the subject of the IR image scan is at a safe distance (e.g., between 6 cm and 60 cm), then proximity sensor 210 will continue to monitor the distance. But if the subject of the IR image scan is not at a safe distance, method 600 may proceed to step 618, and proximity sensor 210 may disable the illumination of LED 220.

At step 618, the illumination of LED 220 may be disabled. For example, as described directly above, the illumination of LED 220 may be disabled by proximity sensor 210 if the subject of the IR image scan is not at a safe distance from LED 220. As described above with reference to FIG. 4, the illumination of LED 220 may be disabled only temporarily if the subject of the IR image scan moves back within a range of safe distances from LED 220. During step 618, the illumination of LED 220 may also be disabled, for the remainder of the active session, by reset circuit 230 or by controller 240. For example, if the timer 231 in reset circuit 230 (which was started at step 612) reaches a threshold amount of time (e.g., thirty seconds) from the time at which LED-on signal 265 is initially driven high, reset circuit 230 may force LED-on signal 265 low, thus disabling the illumination current provided by transistor 224. As another example, if the IR image scan completes before the time limit of reset circuit 230, controller 240 may drive LED-enable signal 260 low, which in turn forces LED-on signal 265 low, thus disabling the illumination current provided by transistor 224. After the illumination of LED 220 has been disabled, method 600 may proceed to step 620.

At step 620, the IR image scan may be disabled. For example, controller 240 may instruct IR camera 250 to stop the IR image scan.

At step 622, a cool-down timer for LED 220 may be started. For example, as described above with reference to step 606, controller 240 may determine a required cool-down time for LED 220 based on the time that LED 220 illuminated the subject of the IR image scan. If the previous IR image scan was not successful, method 600 may return to step 606, and certain steps of method 600 may be repeated after the required cool-down time. However, if the previous IR image scan was successful, method 600 may proceed to step 624.

At step 624, method 600 may complete by ending the IR image scan capture. For example, controller 240 may report the results of the IR image scan (e.g., a facial recognition scan or an iris scan) to the information handling system in which imaging system 200 is incorporated, and may shut down operation of IR camera 250 until another IR image scan is started.

Although the present invention and its advantages have been described in detail, it should be understood that various changes, substitutions and alterations can be made herein without departing from the spirit and scope of the invention as defined by the following claims.

What is claimed is:

1. An imaging system, comprising:
a camera;
a light source;
a controller communicatively coupled to the camera and configured to:
instruct the camera to perform an image scan; and
enable an illumination current for the light source during the image scan; and
a proximity sensor configured to:
detect a distance between the light source and a subject of the image scan; and
provide a proximity override to disable the illumination current during the image scan in response to a determination that the subject is at an unsafe distance from the light source.

2. The imaging system of claim 1, wherein:
the camera is an infrared camera; and
the light source is a light-emitting diode.

3. The imaging system of claim 1, wherein the proximity sensor is further configured to release the proximity override to reestablish the illumination current during the image scan in response to a determination that the subject has moved back within a range of safe distances from the light source.

4. The imaging system of claim 1, wherein the proximity sensor is implemented in hardware configured to provide a software-independent proximity override of the illumination current during an image scan.

5. The imaging system of claim 1, further comprising a reset circuit configured to provide a time override to disable the illumination current after a threshold period of time.

6. The imaging system of claim 5, wherein the reset circuit is implemented in hardware configured to provide a software-independent time override to disable the illumination current after the threshold period of time.

7. The imaging system of claim 1, wherein the proximity sensor is configured to detect whether the subject of the image scan is at a safe distance from the light source between a low threshold and a high threshold prior to the image scan.

8. The imaging system of claim 7, wherein the controller is configured to enable the illumination current at a beginning of the image scan after an initial determination that the subject of the image scan is at the safe distance from the light source between the low threshold and the high threshold.

9. The imaging system of claim 1, wherein the proximity sensor is further configured to:
sense a rate of change between a plurality of distance measurements; and
provide the proximity override to disable the illumination current during the image scan in response to the rate of change exceeding a predetermined rate-of-change threshold.

10. A method for preventing overexposure to light, comprising:
enabling an illumination current for a light source to illuminate a subject of an image scan;
detecting the distance between the light source and the subject of the image scan; and
providing a proximity override to disable the illumination current in response to a determination that the subject is at an unsafe distance from the light source.

11. The method of claim 10, wherein:
the image scan is an infrared image scan; and
the light source is a light-emitting diode.

12. The method of claim 10, further comprising releasing the proximity override to reestablish the illumination current during the image scan in response to a determination that the subject has moved back within a range of safe distances from the light source.

13. The method of claim 10, further comprising:
starting a reset timer in response to the enabling of the illumination current; and
providing a time override to disable the illumination current when the reset timer reaches a threshold period of time.

14. The method of claim 10, detecting whether the subject of the image scan is at a safe distance from the light source between a low threshold and a high threshold prior to beginning image scan.

15. The method of claim 14, that the subject of the image scan is at the safe distance from the light source between the low threshold and the high threshold prior to enabling the illumination current at a beginning of the image scan.

16. The method of claim 15, further comprising:
sensing a rate of change between a plurality of distance measurements; and
providing the proximity override to disable the illumination current during the image scan in response to the rate of change exceeding a predetermined rate-of-change threshold.

17. An imaging system, comprising:
a camera;
a light source;
a primary controller communicatively coupled to the camera and configured to:
instruct the camera to perform an image scan; and
enable an illumination current for the light source during the image scan;
a proximity sensor configured to detect a distance between the light source and a subject of the image scan; and
a hardware controller communicatively coupled to the proximity sensor and configured to dynamically set the magnitude of the illumination current based on the distance detected by the proximity sensor.

18. The imaging system of claim 17, wherein:
the proximity sensor and the hardware controller are implemented in hardware; and
the hardware controller is configured to dynamically adjust the magnitude of the illumination current in a software-independent manner.

19. The imaging system of claim 17, further comprising a reset circuit configured to provide a time override to disable the illumination current after a threshold period of time.

20. The imaging system of claim 19, wherein the reset circuit is implemented in hardware configured to provide a software-independent time override to disable the illumination current after the threshold period of time.
